(19) United States
(12) Patent Application Publication
(10) Pub. No.: US 2015/0181646 A1
(43) Pub. Date: Jun. 25, 2015

(54) METHOD AND SYSTEM FOR BRIDGING AN INPUT SIGNAL FROM A HUMAN INTERFACE DEVICE BETWEEN A COMPUTER AND A MOBILE DEVICE

(71) Applicant: UNIGRAND LTD., New Taipei City (TW)

(72) Inventor: Chien-Wei Wu, New Taipei City (TW)

(73) Assignee: UNIGRAND LTD., New Taipei City (TW)

(21) Appl. No.: 14/262,020

(22) Filed: Apr. 25, 2014

(30) Foreign Application Priority Data
Dec. 19, 2013 (TW) 102147168

(51) Int. Cl. H04W 88/08; G06F 13/38; G06F 3/02

(52) U.S. Cl. CPC H04W 88/085; G06F 3/02; G06F 13/385

(57) ABSTRACT

A method is provided for bridging an input signal from a human interface device between a computer and a mobile device. The computer has a bridging device pluggably coupled thereto. The method includes: executing a bridging application program to configure the computer to serve as a wireless human interface device for the mobile device; in response to generation of an input signal as a result of operation of the human interface device of the computer, transmitting the input signal to the bridging device; in response to receipt of the input signal, transmitting the input signal to the mobile device; and receiving the input signal to serve as an input to an input-requiring application executed by the mobile device.

### CROSS-REFERENCE TO RELATED APPLICATION

This application claims priority of Taiwanese Patent Application No. 102147168, filed on Dec. 19, 2013.

### BACKGROUND OF THE INVENTION

1. Field of the Invention

The present invention relates to a method and a system for bridging an input signal between a computer and a mobile device. The input signal is generated by a human interface device of one of the computer and the mobile device.

2. Description of the Related Art

Due to the rapid development of computer and telecommunication technology, a mobile device, such as a smart phone or a tablet computer, has become more and more popular. It is usually common for a user to have a mobile device in addition to a desktop computer which is used at home or the office. However, even though the mobile device is favorable in view of portability, the way to input data or instructions for the mobile device is relatively inconvenient compared with that for the computer. For example, an ordinary smart phone or tablet computer usually requires a user to tap virtual keys on a touch screen thereof for input of text. Input speed in such way is significantly slower than that of input using a keyboard of a computer.

Although the speed of input using a keyboard of a computer is much faster compared with that of the way of input for the mobile device, an ordinary desktop computer is not portable, and a user is usually required to operate the computer in a fixed position. Therefore, a method or a system which enables a user to implement input to a mobile device by using a computer, or to implement input to a computer by using a mobile device is desirable.

### SUMMARY OF THE INVENTION

Therefore, an object of the present invention is to provide a method and a system for bridging an input signal, which is generated by a human interface device, between a computer and a mobile device.

In a first aspect of the present invention, a method is provided for bridging an input signal between a computer and a mobile device. The input signal is generated by a human interface device of the computer. The computer has a bridging device pluggably coupled thereto. The bridging device and the mobile device are operable to establish a wireless communication link therebetween. The mobile device executes an input-requiring application. The method comprises the steps of:

(A) executing, by the computer, a bridging application program to configure the computer to serve as a wireless human interface device for the mobile device, and to configure the computer for establishing the wireless communication link between the bridging device and the mobile device;

(B) in response to generation of an input signal as a result of operation of the human interface device of the computer while the computer serves as the wireless human interface device, transmitting, by the computer, the input signal to the bridging device;

(C) in response to receipt of the input signal from the computer, transmitting, by the bridging device, the input signal to the mobile device via the wireless communication link established between the bridging device and the mobile device; and

(D) receiving, by the mobile device, the input signal transmitted by the bridging device to serve as an input to the input-requiring application.

Ina second aspect of the present invention, a method is provided for bridging an input signal between a computer and a mobile device. The input signal is generated by a human interface device of the mobile device. The computer has a bridging device pluggably coupled thereto. The bridging device and the mobile device are operable to establish a wireless communication link therebetween. The computer executes an input-requiring application. The method comprises the steps of:

(i) executing, by each of the mobile device and the computer, a corresponding bridging application program to configure the mobile device to serve as a wireless human interface device for the computer, and to configure the mobile device and the computer for establishing the wireless communication link between the mobile device and the bridging device;

(ii) in response to generation of an input signal as a result of operation of the human interface device of the mobile device while the mobile device serves as the wireless human interface device, transmitting, by the mobile device, the input signal to the bridging device via the wireless communication link established between the bridging device and the mobile device;

(iii) in response to receipt of the input signal from the mobile device, transmitting, by the bridging device, the input signal to the computer; and

(iv) receiving, by the computer, the input signal transmitted by the bridging device to serve as an input to the input-requiring application.

In a third aspect of the present invention, a system is provided for bridging an input signal between a computer and a mobile device. The input signal is generated by a human interface device of the computer. The mobile device executes an input-requiring application. The system comprises the computer. The computer has a bridging device pluggably coupled thereto. The bridging device and the mobile device are operable to establish a wireless communication link therebetween. The computer is operable to execute a bridging application program to configure the computer to serve as a wireless human interface device for the mobile device, and to configure the computer for establishing the wireless communication link between the bridging device and the mobile device. In response to generation of an input signal as a result of operation of the human interface device of the computer while the computer serves as the wireless human interface device, the computer is operable to transmit the input signal to the bridging device. In response to receipt of the input signal from the computer, the bridging device is operable to transmit the input signal to the mobile device via the wireless communication link established between the bridging device and the mobile device, so that the mobile device receives the input signal transmitted by the bridging device to serve as an input to the input-requiring application.

In a fourth aspect of the present invention, a system is provided for bridging an input signal between a computer and a mobile device. The input signal is generated by a human interface device of the mobile device. The computer executes an input-requiring application. The system comprises the computer and the mobile device. The computer has a bridging device pluggably coupled thereto. The bridging device and the mobile device are operable to establish a wireless communication link therebetween. Each of the mobile device and the computer is operable to execute a corresponding bridging application program to configure the mobile device to serve as a wireless human interface device for the computer, and to configure the mobile device and the computer for establishing the wireless communication link between the mobile device and the bridging device. In response to generation of an input signal as a result of operation of the human interface device of the mobile device while the mobile device serves as the wireless human interface device, the mobile device is operable to transmit the input signal to the bridging device via the wireless communication link established between the bridging device and the mobile device. In response to receipt of the input signal from the mobile device, the bridging device is operable to transmit the input signal to the computer. The computer is operable to receive the input signal transmitted by the bridging device to serve as an input to the input-requiring application.

In a fifth aspect of the present invention, a system is provided for bridging an input signal between a computer and a mobile device. The input signal is generated by a human interface device of the computer. The mobile device executes an input-requiring application. The system comprises a bridging device and a bridging application program. The bridging device is to be pluggably coupled to computer. The bridging device and the mobile device are operable to establish a wireless communication link therebetween. The bridging application program is to be executed by the computer. The computer is operable to execute the bridging application program to configure the computer to serve as a wireless human interface device for the mobile device, and to configure the computer for establishing the wireless communication link between the bridging device and the mobile device. In response to generation of an input signal as a result of operation of the human interface device of the computer while the computer serves as the wireless human interface device, the computer is operable to transmit the input signal to the bridging device. In response to receipt of the input signal from the computer, the bridging device is operable to transmit the input signal to the mobile device via the wireless communication link established between the bridging device and the mobile device, so that the mobile device receives the input signal transmitted by the bridging device to serve as an input to the input-requiring application.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram which illustrates a preferred embodiment of a system for bridging an input signal from a human interface device between a computer and a mobile device;

FIG. 2 is a flow chart which illustrates a preferred embodiment of a first method for bridging an input signal from a human interface device between a computer and a mobile device;

FIG. 3 is a perspective view illustrating that a keyboard of a computer is used for input of text into a mobile device; and

FIG. 4 is a flow chart which illustrates a preferred embodiment of a second method for bridging an input signal from a human interface device between a computer and a mobile device.

### DETAILED DESCRIPTION OF THE PREFERRED EMBODIMENTS

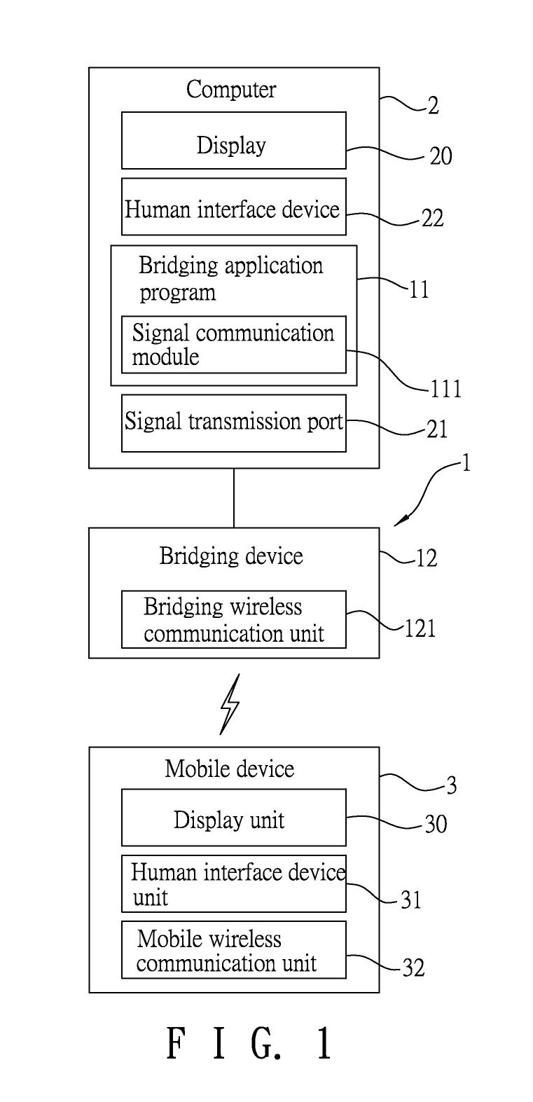

Referring to FIG. 1, a preferred embodiment of a system 1 for bridging an input signal from a human interface device between a computer 2 and a mobile device 3 is illustrated. The computer 2 includes a display 20, a signal transmission port 21, and a human interface device 22. The input signal is generated by the human interface device 22 of the computer 2. In this embodiment, the signal transmission port 21 is a universal serial bus (USB) port. Preferably, the human interface device 22 is selected from a keyboard, a mouse, a microphone and combinations thereof. The mobile device 3 includes a display unit 30, a human interface device unit 31 and a mobile wireless communication unit 32. Preferably, the human interface device unit 31 is selected from a physical key, a virtual key, a microphone and combinations thereof. The mobile device 3 executes an input-requiring application.

The system 1 comprises a bridging application program 11 and a bridging device 12. The bridging application program 11 is to be executed by the computer 2, and includes a signal communication module 111. In this embodiment, the bridging device 12 is a USB bridging device, is pluggably coupled to the signal transmission port 21 of the computer 2, and includes a bridging wireless communication unit 121. The bridging device 12 and the mobile device 3 are operable to establish a wireless communication link therebetween. The bridging device 12 is associated with a USB class identification (ID) code, a vendor ID code, and a product ID code. The USB class ID code is set to be “FFh” that corresponds to a vendor-specific class, and the vendor ID code and the product ID code are recognizable by the bridging application program 11. In this embodiment, the computer 2 is configured by the signal communication module 111 of the bridging application program 11 to communicate with the bridging wireless communication unit 121 of the bridging device 12 according to the Bluetooth Host Controller Interface (HCI). Further, the bridging wireless communication unit 121 of the bridging device 12 and the mobile wireless communication unit 32 of the mobile device 3 are preferably configured to communicate with each other according to the Bluetooth Human Interface Device (HID) Profile.

In this preferred embodiment, even though the data communications among the mobile wireless communication unit 32, the signal communication module 111 and the bridging wireless communication unit 121 are implemented by means of Bluetooth communication protocols, other communication protocols may be utilized to implement the present invention.

Specifically, even if the bridging device 12 is configured to implement data communications by means of Bluetooth communication protocols, unlike an ordinary USB Bluetooth bridging device whose USB class ID code is set to be “E0h” that corresponds to a wireless controller class, the bridging device 12 of the present invention has the USB class ID code set to be “FFh” that corresponds to the vendor-specific class. In this way, the computer 2 may not recognize the bridging device 12 to be a standard Bluetooth device. Moreover, if the computer 2 is built with another Bluetooth device, the bridging device 12 and the built-in Bluetooth device may be prevented from conflicting or interfering with each other.

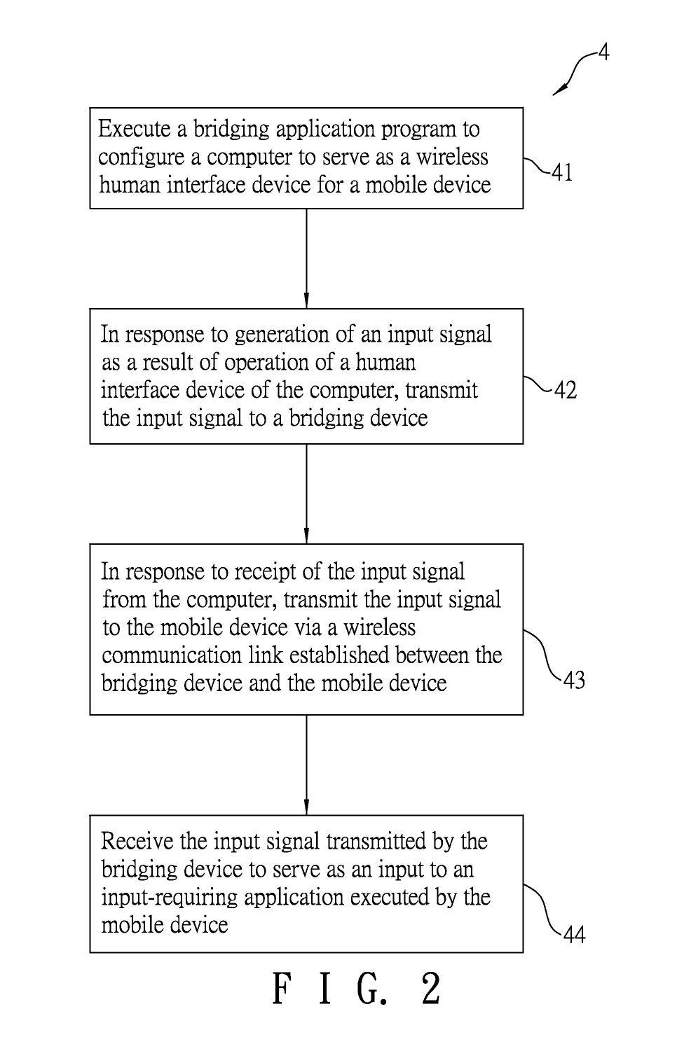

The system 1 may be switched between a first mode and a second mode. Referring to FIG. 1 and FIG. 2, a preferred embodiment of a first method 4 for bridging an input signal from a human interface device between a computer and a mobile device, according to the present invention, is to be performed in the first mode of the system 1.

In step 41, the computer 2 is operable to execute the bridging application program 11 to configure the computer 2 to serve as a wireless human interface device for the mobile device 3, and to configure the computer 2 for establishing the wireless communication link between the bridging device 12 and the mobile device 3.

In step 42, in response to generation of an input signal as a result of operation of the human interface device 22 of the computer 2 while the computer 2 serves as the wireless human interface device, the computer 2 is configured by the signal communication module 111 of the bridging application program 11 to transmit the input signal to the bridging device 12. The input signal generated by the human interface device 22 corresponds to a key press of the keyboard of the computer 2, operation of the mouse of the computer 2, or sound pick-up by the microphone of the computer 2.

In step 43, in response to receipt of the input signal from the computer 2, the bridging wireless communication unit 121 of the bridging device 12 is operable to transmit the input signal to the mobile device 3 via the wireless communication link established between the bridging device 12 and the mobile device 3.

In step 44, the mobile device 3 is operable to receive the input signal transmitted by the bridging wireless communication unit 121 of the bridging device 12 to serve as an input to the input-requiring application which is being executed by the mobile device 3.

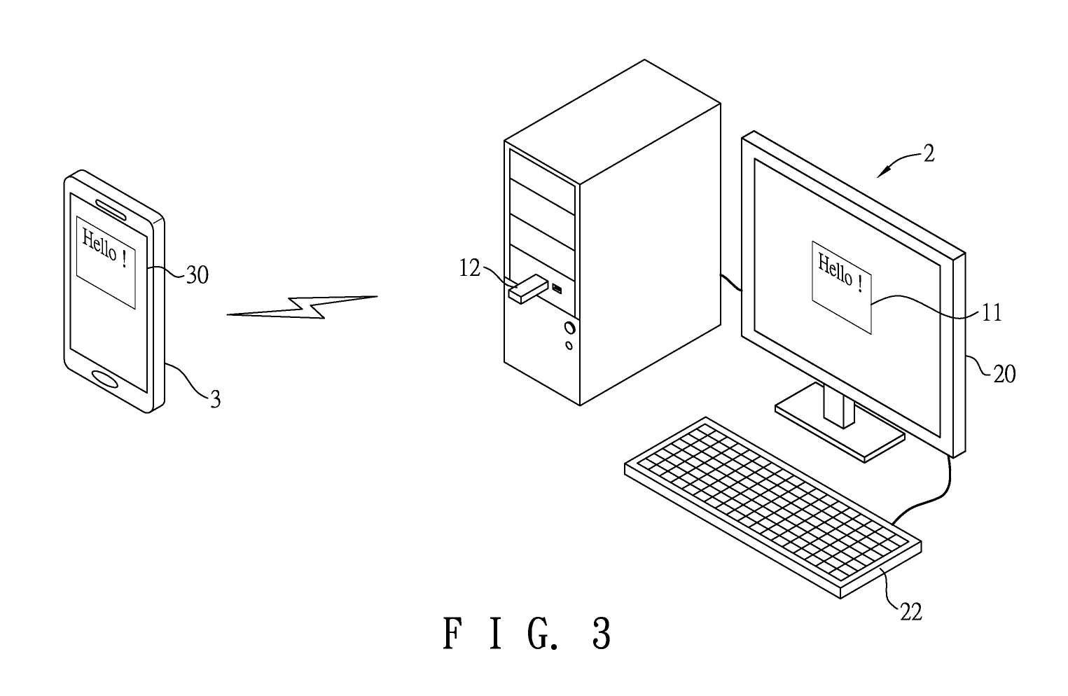

For example, referring FIG. 1 and FIG. 3, when a user intends to edit a message through a message application program executed by the mobile device 3, the user may use the keyboard of the computer 2 to perform text input on the computer 2 via the bridging application program 11, such as key press of the keyboard or copy/paste operations (Ctrl+C, Ctrl+V) for inputting “Hello!”. Subsequently, the bridging application program 11 configures the computer 2 to transmit the input signal which corresponds to “Hello!” via the bridging wireless communication unit 121 of the bridging device 12 to the mobile wireless communication unit 32 of the mobile device 3, such that the input signal serves as an input to the message application program and is displayed on the display unit 30 of the mobile device 3. It is noted that since the mobile wireless communication unit 32 is configured to communicate with the bridging wireless communication unit 121 according to the Bluetooth HID Profile, the bridging device 12 may be recognized by the mobile device 3 as a standard input device. Therefore, the mobile device 3 is not required to install additional software or programs for implementing the first method 4 of the present invention.

Furthermore, in the aforementioned example, aside from using the keyboard of the computer 2 for text input, if the computer 2 is provided with voice-to-text software, voice input may be implemented via the microphone of the computer 2, and then the voice input may be converted into text strings by the voice-to-text software which is called by the bridging application program 11. Subsequently, the bridging application program 11 configures the computer 2 to transmit the text strings via the bridging device 12 to the mobile device 3, so as to serve as content of the message.

Preferably, in step 42, the input signal is a real-time input signal that is transmitted by the computer 2 to the bridging device 12 in real time. In step 43, the bridging device 12 transmits the input signal received from the computer 2 to the mobile device 3 in real time.

In addition, the Bluetooth communications utilized in the first method 4 may be implemented according to the Basic Rate/Enhanced Rate (BR/EDR) mode of Bluetooth version 2.1 or the Bluetooth Lower Energy (BLE) mode of Bluetooth version 4.0. Specifically, when the Bluetooth communications are implemented according to the BLE mode, text strings inputted via the keyboard of the computer 2 may be transmitted to the mobile device 3 in a form of Unicode. On the other hand, when the BR/EDR mode is used to implement the Bluetooth HID Profile, text strings in the form of Unicode cannot be transmitted, and only text strings in a form of American Standard Code for Information Interchange (ASCII) can be transmitted.

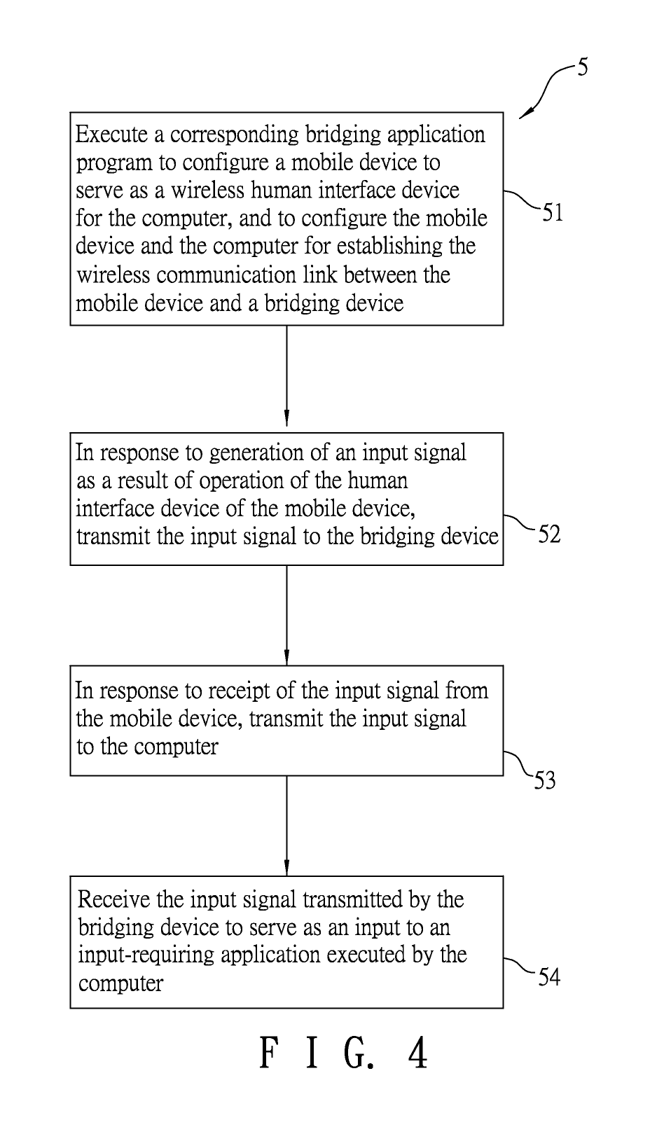

Referring to FIG. 1 and FIG. 4, a preferred embodiment of a second method 5 for bridging an input signal from a human interface device unit between a computer and a mobile device, according to the present invention, is to be performed in the second mode of the system 1. The input signal is generated by the human interface device unit 31 of the mobile device 3. The computer 2 has the bridging device 12 pluggably coupled thereto. The bridging device 12 and the mobile device 3 are operable to establish a wireless communication link therebetween. The computer 2 executes an input-requiring application. The preferred embodiment of the method 5 comprises the following steps.

In step 51, each of the mobile device 3 and the computer 2 is operable to execute a corresponding bridging application program (e.g., the bridging application program 11 to be executed by the computer 2) to configure the mobile device 3 to serve as a wireless human interface device for the computer 2, and to configure the mobile device 3 and the computer 2 for establishing the wireless communication link between the mobile device 3 and the bridging device 12.

In step 52, in response to generation of an input signal as a result of operation of the human interface device unit 31 of the mobile device 3 while the mobile device 3 serves as the wireless human interface device, the mobile wireless communication unit 32 of the mobile device 3 is operable to transmit the input signal to the bridging device 12 via the wireless communication link established between the bridging device 12 and the mobile device 3. The input signal generated by the human interface device unit 31 corresponds to a key press of the physical key of the mobile device 3, a tap on the virtual key of the mobile device 3, or a sound pick-up by the microphone of the mobile device 3.

In step 53, in response to receipt of the input signal from the mobile wireless communication unit 32 of the mobile device 3, the bridging wireless communication unit 121 of the bridging device 12 is operable to transmit the input signal to the computer 2.

In step 54, the computer 2 is operable to receive the input signal transmitted by the bridging wireless communication unit 121 of the bridging device 12 to serve as an input to the input-requiring application executed by the computer 2 and to be displayed on the display 20. In this preferred embodiment, the input-requiring application executed by the computer 2 is the bridging application program 11.

For example, when the user intends to write an article through word processor software executed by the computer 2, the user may operate the mobile device 3 to execute the corresponding bridging application program so as to perform voice input via the microphone of the mobile device 3. Subsequently, the corresponding bridging application program configures the mobile device 3 to transmit the input signal which corresponds to the voice input via the bridging wireless communication unit 121 of the bridging device 12 to the computer 2. The bridging application program 11 executed by the computer 2 is designed to call the voice-to-text software to convert the input signal into text content, such that the text content is displayed on the display 20 of the computer 2 and serves as content of the article.

Moreover, in another preferred embodiment of the system 1, the system 1 may not be switched between the first mode and the second mode, and may perform the first method 4 and the second method 5 simultaneously. Specifically, the first method 4 and the second method 5 may adopt the BR/EDR mode and the BLE mode respectively for implementing Bluetooth communications. As an example, the iPhone which runs iOS version 7 or later versions is able to implement the BR/EDR mode and the BLE mode at the same time.

To sum up, in the method and the system for bridging an input signal from a human interface device between a computer and a mobile device, according to the present invention, by means of installation of the bridging application program 11 and disposition of the bridging device 12, by means of the communications between the computer 2 and the bridging wireless communication unit 121 of the bridging device 12 according to the Bluetooth HCI, and by means of the communications between the bridging wireless communication unit 121 of the bridging device 12 and the mobile wireless communication unit 32 of the mobile device 3 according to the Bluetooth HID Profile, the user is able to perform input to the mobile device 3 via the human interface device 22 of the computer 2. The user is also able to perform input to the computer 2 via the human interface device unit 31 of the mobile device 3. In addition, conflict or interference between the bridging device 12 and the built-in Bluetooth device in the computer 2 may be prevented.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for bridging an input signal between a computer and a mobile device, the input signal being generated by a human interface device of the computer, the computer having a bridging device pluggably coupled thereto, the bridging device and the mobile device being operable to establish a wireless communication link therebetween, the mobile device executing an input-requiring application, the method comprising the steps of:
(A) executing, by the computer, a bridging application program to configure the computer to serve as a wireless human interface device for the mobile device, and to configure the computer for establishing the wireless communication link between the bridging device and the mobile device;
(B) in response to generation of an input signal as a result of operation of the human interface device of the computer while the computer serves as the wireless human interface device, transmitting, by the computer, the input signal to the bridging device;
(C) in response to receipt of the input signal from the computer, transmitting, by the bridging device, the input signal to the mobile device via the wireless communication link established between the bridging device and the mobile device; and
(D) receiving, by the mobile device, the input signal transmitted by the bridging device to serve as an input to the input-requiring application.

2. The method according to claim 1, wherein the bridging device is associated with a universal serial bus (USB) class identification (ID) code corresponding to a vendor-specific class.

3. The method according to claim 1, wherein:
in step (B), the input signal is a real-time input signal that is transmitted by the computer to the bridging device in real time; and
in step (C), the bridging device transmits the input signal received from the computer to the mobile device in real time.

4. The method according to claim 1, wherein the computer is configured to communicate with the bridging device according to the Bluetooth Host Controller Interface (HCI), and the bridging device and the mobile device are configured to communicate with each other according to the Bluetooth Human Interface Device (HID) Profile.

5. The method according to claim 1, wherein the human interface device is selected from a keyboard, a mouse, a microphone and combinations thereof, and the input signal generated by the human interface device corresponds to a key press of the keyboard, operation of the mouse, or sound pick-up by the microphone.

6. A method for bridging an input signal between a computer and a mobile device, the input signal being generated by a human interface device of the mobile device, the computer having a bridging device pluggably coupled thereto, the bridging device and the mobile device being operable to establish a wireless communication link therebetween, the computer executing an input-requiring application, the method comprising the steps of:
(i) executing, by each of the mobile device and the computer, a corresponding bridging application program to configure the mobile device to serve as a wireless human interface device for the computer, and to configure the mobile device and the computer for establishing the wireless communication link between the mobile device and the bridging device;
(ii) in response to generation of an input signal as a result of operation of the human interface device of the mobile device while the mobile device serves as the wireless human interface device, transmitting, by the mobile device, the input signal to the bridging device via the wireless communication link established between the bridging device and the mobile device;
(iii) in response to receipt of the input signal from the mobile device, transmitting, by the bridging device, the input signal to the computer; and
(iv) receiving, by the computer, the input signal transmitted by the bridging device to serve as an input to the input-requiring application.

7. The method according to claim 6, wherein the bridging device is associated with a universal serial bus (USB) class identification (ID) code corresponding to a vendor-specific class.

8. The method according to claim 6, wherein:
in step (ii), the input signal is a real-time input signal that is transmitted by the mobile device to the bridging device in real time; and
in step (iii), the bridging device transmits the input signal received from the mobile device to the computer in real time.

9. The method according to claim 6, wherein the computer is configured to communicate with the bridging device according to the Bluetooth Host Controller Interface (HCI), and the bridging device and the mobile device are configured to communicate with each other according to the Bluetooth Human Interface Device (HID) Profile.

10. The method according to claim 6, wherein the human interface device is selected from a physical key, a virtual key, a microphone and combinations thereof, and the input signal generated by the human interface device corresponds to a key press of the physical key, a tap on the virtual key, or a sound pick-up by the microphone.

11. A system for bridging an input signal between a computer and a mobile device, the input signal being generated by a human interface device of the computer, the mobile device executing an input-requiring application, the system comprising:
the computer which has a bridging device pluggably coupled thereto, the bridging device and the mobile device being operable to establish a wireless communication link therebetween;
wherein the computer is operable to execute a bridging application program to configure the computer to serve as a wireless human interface device for the mobile device, and to configure the computer for establishing the wireless communication link between the bridging device and the mobile device;
wherein, in response to generation of an input signal as a result of operation of the human interface device of the computer while the computer serves as the wireless human interface device, the computer is operable to transmit the input signal to the bridging device; and
wherein, in response to receipt of the input signal from the computer, the bridging device is operable to transmit the input signal to the mobile device via the wireless communication link established between the bridging device and the mobile device, so that the mobile device receives the input signal transmitted by the bridging device to serve as an input to the input-requiring application.

12. The system according to claim 11, wherein the bridging device is associated with a universal serial bus (USB) class identification (ID) code corresponding to a vendor-specific class.

13. The system according to claim 11,
wherein the input signal is a real-time input signal that is transmitted by the computer to the bridging device in real time; and
wherein the bridging device transmits the input signal received from the computer to the mobile device in real time.

14. The method according to claim 11, wherein the computer is configured to communicate with the bridging device according to the Bluetooth Host Controller Interface (HCI), and the bridging device and the mobile device are configured to communicate with each other according to the Bluetooth Human Interface Device (HID) Profile.

15. The method according to claim 11, wherein the human interface device is selected from a keyboard, a mouse, a microphone and combinations thereof, and the input signal generated by the human interface device corresponds to a key press of the keyboard, operation of the mouse, or sound pick-up by the microphone.

16. A system for bridging an input signal between a computer and a mobile device, the input signal being generated by a human interface device of the mobile device, the computer executing an input-requiring application, the system comprising:
the computer which has a bridging device pluggably coupled thereto; and
the mobile device, wherein the bridging device and the mobile device are operable to establish a wireless communication link therebetween;
wherein each of the mobile device and the computer is operable to execute a corresponding bridging application program to configure the mobile device to serve as a wireless human interface device for the computer, and to configure the mobile device and the computer for establishing the wireless communication link between the mobile device and the bridging device;
wherein, in response to generation of an input signal as a result of operation of the human interface device of the mobile device while the mobile device serves as the wireless human interface device, the mobile is operable to transmit the input signal to the bridging device via the wireless communication link established between the bridging device and the mobile device;
wherein, in response to receipt of the input signal from the mobile device, the bridging device is operable to transmit the input signal to the computer; and
wherein the computer is operable to receive the input signal transmitted by the bridging device to serve as an input to the input-requiring application.

17. The system according to claim 16, wherein the bridging device is associated with a universal serial bus (USB) class identification (ID) code corresponding to a vendor-specific class.

18. The system according to claim 16,
wherein the input signal is a real-time input signal that is transmitted by the mobile device to the bridging device in real time; and
wherein the bridging device transmits the input signal received from the mobile device to the computer in real time.

19. The system according to claim 16, wherein the computer is configured to communicate with the bridging device according to the Bluetooth Host Controller Interface (HCI), and the bridging device and the mobile device are configured to communicate with each other according to the Bluetooth Human Interface Device (HID) Profile.

20. The system according to claim 16, wherein the human interface device is selected from a physical key, a virtual key, a microphone and combinations thereof, and the input signal generated by the human interface device corresponds to a key press of the physical key, a tap on the virtual key, or a sound pick-up by the microphone.

21. A system for bridging an input signal between a computer and a mobile device, the input signal being generated by a human interface device of the computer, the mobile device executing an input-requiring application, the system comprising:
a bridging device which is to be pluggably coupled to the computer, wherein the bridging device and the mobile device are operable to establish a wireless communication link therebetween; and
a bridging application program which is to be executed by the computer;
wherein the computer is operable to execute the bridging application program to configure the computer to serve as a wireless human interface device for the mobile device, and to configure the computer for establishing the wireless communication link between the bridging device and the mobile device;
wherein, in response to generation of an input signal as a result of operation of the human interface device of the computer while the computer serves as the wireless human interface device, the computer is operable to transmit the input signal to the bridging device; and
wherein, in response to receipt of the input signal from the computer, the bridging device is operable to transmit the input signal to the mobile device via the wireless communication link established between the bridging device and the mobile device, so that the mobile device receives the input signal transmitted by the bridging device to serve as an input to the input-requiring application.
